(19) United States
(12) Patent Application Publication
(10) Pub. No.: US 2021/0247415 A1
(43) Pub. Date: Aug. 12, 2021

(54) AIRBORNE SOUND TRANSDUCER FOR USE IN PRECIPITATION AND THAW CONDITIONS

(71) Applicant: Adolf Thies GmbH & Co. KG, Goettingen (DE)

(72) Inventor: Herbert Windolph, Duderstadt (DE)

(21) Appl. No.: 17/242,461

(22) Filed: Apr. 28, 2021

Related U.S. Application Data
(63) Continuation of application No. PCT/EP2019/079404, filed on Oct. 28, 2019.

(30) Foreign Application Priority Data
Nov. 2, 2018 (DE) 10 2018 127 377.0

(51) Int. Cl. G01P 5/24

(52) U.S. Cl. CPC G01P 5/241

(57) ABSTRACT

An airborne sound transducer comprises an electromechanical transducer, an air impedance matching layer arranged on an acoustically active surface of the electromechanical transducer, and a cover arranged on the air impedance matching layer, an outer surface of the cover forming an exposed acoustic area of the airborne sound transducer. The outer surface is hydrophilic such that a contact angle of water on the outer surface is less than 60°.

### CROSS REFERENCE TO RELATED APPLICATIONS

This application is a continuation to international Application PCT/EP2019/079404 with an international filing date of Oct. 28, 2019 entitled “Airborne sound transducer, more particularly ultrasonic transducer, for use in precipitation and thaw conditions” and claiming priority to co-pending German Patent Application No. DE 10 2018 127 377.0 entitled “Luftschallwandler, insbesondere Ultraschallwandler, für den Einsatz unter Niederschlags- and Betauungs-Bedingungen” and filed on Nov. 2, 2018.

### FIELD OF THE INVENTION

The present invention generally relates to an airborne sound transducer. More particularly, the invention relates to an airborne sound transducer, like, for example, an ultrasonic or ultrasound transducer, comprising an electromechanical transducer, an air impedance matching layer arranged on an acoustically active surface of the electromechanical transducer, and a cover arranged on the air impedance matching layer, an outer surface of the cover forming an exposed acoustic area of the airborne sound transducer. Further, the invention relates to an apparatus comprising such an airborne sound transducer and to an ultrasound anemometer comprising a reflector and at least two such airborne sound transducers.

As indicated above, the airborne sound transducer according to the present invention may be an ultrasonic or ultrasound transducer. However, the airborne sound transducer according to the invention, may also be used at lower frequencies than those of ultrasound, i.e. also at frequencies below 16 kHz.

### BACKGROUND OF THE INVENTION

In an airborne sound transducer, an air impedance matching layer which is also designated as a λ/4 matching layer serves for matching different impedances, which are defined as products of density and sound velocity, of a material of an electromechanical transducer and of air or any other gas prevalent in the surroundings of the airborne sound transducer.

That the air impedance matching layer is arranged on an acoustically active surface of the electromechanical transducer does not exclude that a further layer is arranged between the acoustically active surface and the air impedance matching layer.

A cover arranged on the air impedance matching layer typically serves for avoiding the entry of foreign matters into the air impedance matching layer. Thus, the cover typically has a closed surface.

An ultrasound transducer for application in extreme climatic conditions having an exposed acoustic surface, particularly for use in ultrasound anemometry, is known from German patent application publication DE 101 58 144 A1 and US patent application publication US 2005/0 022 591 A1 belonging to the same patent family. The ultrasound transducer includes an electromechanical transducer which has an acoustically active surface, an acoustic matching layer which is arranged between the acoustically active surface and an exposed acoustic area, and a heating element which is arranged between the acoustic active surface of the electromechanical transducer and the acoustic matching layer. The heating element serves for heating up the exposed acoustic area to melt up and evaporate any ice, frost or water precipitated thereon.

Water drops on the exposed acoustic surface of an ultrasound transducer may deform the radiation lobes and generate side radiation lobes. In this way, the function of an ultrasound anemometer, particularly the function of an ultrasound anemometer comprising a reflector via which the individual ultrasound transducers of a plurality of ultrasound transducers oppose each other, is strongly affected. From the exposed acoustic area of the ultrasound transducer known from DE 101 58 144 A1 and US 2005/0022591 A1, water drops can only be removed slowly by evaporation using the heating element. Further, the known ultrasound transducer ages due to thermal load if its exposed acoustic area if often kept at a sufficiently high temperature to evaporate any water drops occurring.

An ultrasound transducer for detecting the filling level or the quality of a fluid of a combustion engine is known from German patent application publication DE 10 2017 209 471 A1. This ultrasound transducer comprises a sound transducer which is configured to emit and receive ultrasound waves, and a sound guiding element arranged in the fluid. The sound guiding element includes a sound guiding section which is configured to at least partially guide the ultrasound waves emitted by the sound transducer prior to their coupling into the fluid, and a sound coupling section. The sound coupling section is configured to couple the ultrasound waves guided by the sound guiding section into the fluid such that the ultrasound waves are at least partially emitted in a direction towards the fluid surface. The sound coupling section of the sound guiding element is provided with a coating inhibiting depositions on the sound coupling element. This coating, for example, includes a metallic coating. Further, depending on the prevalent fluid, the coating may be hydrophobic, hydrophilic, lipophobic or lipophilic.

An ultrasound transducer comprising an electromechanical transducer and an air impedance matching layer made as a porous polymer membrane and arranged on an acoustically active surface of the electromechanical transducer is known from Japanese patent application publication JP S61-169099 A. The electromechanical transducer is hydrophobic. In order to avoid entry of a glue used for gluing the porous polymer membrane to the transducer into the generally hydrophilic porous polymer membrane and to protect the polymer membrane against moisture, the polymer membrane is hydrophobized.

There still is the need of an airborne sound transducer whose function is not affected by rain and other drop forming precipitation and which may thus be used in apparatuses, particularly ultrasound anemometers, which are subject to bad weather conditions.

### SUMMARY OF THE INVENTION

The present invention relates to an airborne sound transducer. The airborne sound transducer comprises an electromechanical transducer, an air impedance matching layer arranged on an acoustically active surface of the electromechanical transducer, and a cover arranged on the air impedance matching layer, an outer surface of the cover forming an exposed acoustic area of the airborne sound transducer. The outer surface is hydrophilic such that a contact angle of water on the outer surface is less than 60°.

The present invention further relates to an apparatus. The apparatus comprises an airborne sound transducer according to the present invention, and a water pickup arm which laterally extends in front of a lowermost area of the outer surface.

The present invention further relates to an ultrasound anemometer. The ultrasound anemometer comprises a reflector and at least two airborne sound transducers according to the present invention. The at least two airborne sound transducers are directed towards a reflector surface and oppose each other when viewed in sound propagation direction via the reflector surface.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1A is a perspective sectional view of outer parts of an airborne sound transducer according to the present disclosure, whereas

FIG. 1B is a side view of inner parts of the airborne sound transducer according to the present disclosure, which are omitted in FIG. 1A.

FIG. 2 shows an ultrasound anemometer comprising four ultrasound transducers according to the present disclosure in a side view.

FIG. 3 shows the ultrasound anemometer according to FIG. 2 in a perspective side view.

FIG. 4 is an enlarged detail of FIG. 3; and

FIG. 5 illustrates a contact angle of water on an outer surface of the airborne sound transducer according to the present disclosure.

### DETAILED DESCRIPTION

In an airborne sound transducer according to the present disclosure comprising an electromechanical transducer, an air impedance matching layer arranged on an acoustically active surface of the electromechanical transducer and a cover arranged on the air impedance matching layer, an outer surface of the cover, which forms an exposed acoustic area of the airborne sound transducer, is hydrophilic. A hydrophilic outer surface is to be understood in that a contact angle of water on the outer surface is less than 60°.

The outer surface of the cover forms the exposed acoustic area of the airborne sound transducer via which sound is radiated or received. Typically, the cover is closed. This is to be understood in that it has no or at least no openings through which water could pass through.

The contact angle indicates the level of hydrophilia of the outer surface. The smaller the contact angle the higher the hydrophilia. The contact angle depends on the ratio of the boundary surface tensions between the wetting liquid and the outer surface, between the air in the surroundings and the wetting liquid, and between the air in the surroundings and the outer surface. Besides material properties, a structure of the outer surface may have a relevant effect on the boundary surface tension between the water and the outer surface.

Insofar as a reference is made to air in the surroundings of the airborne sound transducer and to an air impedance matching layer, this reference does not exclude a use of the airborne sound transducer in other gaseous surroundings or an adaptation of the air impedance matching layer and the hydrophilia of the outer surface of the cover of the air impedance matching layer to other gases than air in the respective surroundings of the airborne sound transducer.

Due to the hydrophilia of the outer surface of the airborne sound transducer according to the present disclosure, the formation of water drops on this outer surface is avoided. Instead, aqueous precipitation on the outer surface is spread out, i.e. the precipitated water is areally and quickly distributed, often over the entire outer surface. An areal wetting of the outer surface, which is the exposed acoustic area of the airborne sound transducer according to the present disclosure, does not significantly deform the radiation lobe into which the airborne sound is radiated by the airborne sound transducer, as opposed to a water drop formed on the outer surface. This particularly applies, if the hydrophilia of the outer surface is so high that the contact angle of water is smaller than 40°, smaller than 20° or even smaller than 10°.

Practically, the hydrophilic outer surface of the airborne sound transducer according to the present disclosure may be a hydrophilized metal surface. A hydrophilization of the metal surface may, depending on the composition of the metal surface, be effected by oxidation and/or carbonization and/or roughening. For example, a metal part of the metal surface may at least predominantly consist of zinc, copper, stainless steel or titanium. Zinc and copper may, for example, be hydrophilized by carbonization using acidulated water or hydrophilized by oxidation due to exposure to air. Stainless steel and titanium can be hydrophilized by roughening, like, for example, by means of abrading or sandblasting, or hydrophilized by oxidative aging. A hydrophilized metal surface made of, for example, stainless steel or titanium is not only stable as an outer surface but also retains its hydrophilia permanently. Contrariwise, with many known hydrophilizing coatings made of plastic, no stability of the hydrophilia of the outer surface is achieved over several or even many years.

In an embodiment of the airborne sound transducer of the present disclosure, the hydrophilized metal surface may be the outer surface of a shaped body made of thin metal sheet whose sheet thickness is typically between 0.05 and 0.2 mm. This shaped body of thin metal sheet may, in principle, be directly arranged on the air impedance matching layer. Alternatively, it may be arranged on a cover layer made of plastic, which is part of an elastic protective sleeve enclosing the air impedance matching layer.

In an apparatus according to the present disclosure comprising an airborne sound transducer according to the present disclosure, a water pickup arm laterally extends up to in front of a lowermost area of the outer surface. The designation “lowermost area of the outer surface” refers to that area of all areas of the outer surface that, in the operation of the airborne sound transducer or the apparatus including the airborne sound transducer, is at the lowest level in the direction of the force of gravity. Water spread out over the outer surface accumulates in this lowermost area of the outer surface due to its gravity and thus gets into contact with the water pickup arm. If the water pickup arm has a hydrophilic surface, wherein a contact angle of water on the hydrophilic surface is even smaller than the contact angle of water on the outer surface of the airborne sound transducer according to the present disclosure, the water pickup arm removes the water that gets into contact with the pickup arm from the outer surface. Thus, by means of the water pickup arm, an accumulation of a thicker layer of water on the outer surface is avoided, if the water is only spread out over the outer surface but not over adjacent hydrophobic areas, like, for example, the surface of an elastic protective cover enclosing the air impedance matching layer.

In a direction oriented normal or orthogonal to the outer surface, a free end of the water pickup arm may end at a distance in a range from about 0.05 mm to about 1.0 mm or in a range from about 0.1 to about 0.5 mm in front of the outer surface of the airborne sound transducer according to the present disclosure. In a lateral direction parallel to the plane of main extension of the outer surface, the free end of the water pickup arm may end in a range extending from 0.1 mm besides or next to the outer surface to 2 mm overlap with the outer surface or in a range extending from 0.05 mm besides or next to the outer surface to 0.5 mm overlap with the outer surface. Due to its at most little overlap with the outer surface, the water pickup arm does not disturb the airborne sound radiated via the outer surface. At the same time, the water pickup arm is so close to the outer surface that even a water layer of little thickness on the outer surface gets into contact with the water pickup arm and is thus removed by the water pickup arm.

In the apparatus according to the present disclosure, an end of the water pickup arm opposing its free end, which is designated as a base of the water pickup arm here, may be located at least 0.5 mm or at least 1 mm or at least 2 mm or even at least 5 mm below the lowermost area of the outer surface. These indications once again refer to the orientation of the apparatus according to the present disclosure in operation of the ultrasonic transducer according to the present disclosure. In this way, the gravity of the water picked up with the water pickup arm is utilized to move the water towards the base of the water pickup arm. This base of the water pickup arm may be arranged in a drainage groove whose bottom falls off away from the base to remove the water even further. Practically, the drainage groove may be formed in a shaped body at which the water pickup arm is supported in a spatially fixed way and with regard to which the airborne sound transducer is sealed with an elastic seal. The shaped body as such may also have a hydrophilic surface. Then, the drainage grooves are less important or even unnecessary for removing the water. If, however, the shaped body has no hydrophilic or even a hydrophobic surface, drainage grooves are a great advantage in further removing of the water. A slope of the drainage groove in the shaped body may be at least 10% or even at least 20%, but the drainage groove does not need to have such a slope over its entire length. However, the drainage groove preferably has a slope towards its open end facing away from the base of the water pickup arm. The elastic sealing by which the airborne sound transducer is sealed with regard to the shaped body of the apparatus according to the present disclosure also serves for a vibration isolation. Practically, the elastic seal may be a part of an elastic protective sleeve enclosing the air impedance matching layer of the airborne sound transducer according to the present disclosure.

In an ultrasonic anemometer according to the present disclosure comprising a reflector and at least two airborne sound transducers according to the present disclosure or one or more apparatuses according to the present disclosure, which include at least two airborne sound transducers according to the present disclosure, the at least two airborne sound transducers are directed onto a reflector surface of the reflector, and the at least two airborne sound transducers face each other when viewed in sound propagation direction via the reflector surface. Thus, the one of the at least two airborne sound transducers receives the airborne sound from the other of the at least two airborne sound transducers according to the present disclosure after reflection of the airborne sound at the reflector surface. The avoidance of drop formation on the hydrophilic outer surfaces of the airborne sound transducers ensures that no scattering of the airborne sound occurs at the outer surfaces so that no airborne sound gets from the one to the other of the at least two airborne sound transducers of the present disclosure on a direct way, i.e. without reflection at the reflector surface.

In the ultrasound anemometer according to the present disclosure, the reflector surface may also be hydrophilic. Practically, the reflector may be made of stainless steel, and the reflector surface facing the airborne sound transducers may be hydrophilized by at least one of roughening the stainless steel and by oxidative aging.

In order to measure horizontal wind velocity with the ultrasound anemometer according to the present disclosure, the reflector surface may be arranged horizontally above or below the airborne sound transducers. It is to be understood that, in order to measure the wind velocity in all horizontal directions, at least three airborne sound transducers have to be provided and preferably four airborne sound transducers are arranged in two pairs of airborne sound transducers facing each other via the reflector surface in two orthogonal directions.

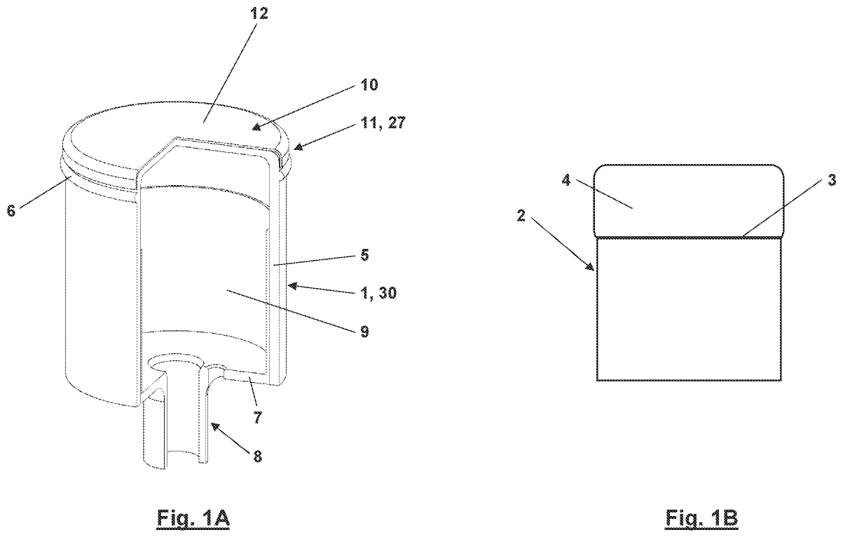

Referring now in greater detail to the drawings, the airborne sound transducer 1, whose outer parts are shown in FIG. 1A and whose inner parts are shown in FIG. 1B, comprises an electromechanical transducer 2. As shown in FIG. 1B, an air impedance matching layer 4 is arranged on an acoustically active surface 3 of the electromechanical transducer 2. The air impedance matching layer 4 and the adjacent electromechanical transducer 2 are enclosed by a protective sleeve 5 made of an elastic plastic, which is depicted in FIG. 1A. The protective sleeve 5 forms a sealing bulge 6 and connects to a base element 7 which forms a feedthrough 8 for connection lines which lead to the electromechanical transducer 2 arranged in a clearance 9 in the base element 7 but which are not depicted here. An exposed acoustic area 10 via which the airborne sound transducer 1 radiates airborne sound, particularly ultrasound, is formed by a shaped body 11 made of thin metal sheet of a thickness of less than 0.5 mm or even of not more than 0.2 mm. The thin metal sheet shaped body is, for example, made of titanium, and an outer surface 12 of the thin metal sheet shaped body 11 which forms the exposed acoustic area 10 is, for example by means of roughening, hydrophilized such that a contact angle of water on the outer surface 12 is preferably smaller than 20° and even more preferably smaller than 10°.

Despite the fact that, in FIG. 1A, the air impedance matching layer 4 is arranged directly on the acoustically active surface 3 of the electromechanical transducer 2, a further layer, like, for example, a layer forming a heating element, may be arranged in between. With such a heating element a built up of ice on the outer surface 12 can be avoided.

For example in ultrasound anemometry but also in measuring distances with ultrasound, for determining a signal runtime, an acoustic pulse or wave train is generated with an airborne sound transducer 1 which is designed as an ultrasound transducer 30 and converted back into an electrical signal by means of a further similar airborne sound transducer 1 which is also designed as an ultrasound transducer 30 on a receiver side. Particularly then, when the acoustic signal propagates via a reflector 13 as depicted in the following drawings to minimize obstruction of a flowing medium whose velocity is of interest by the ultrasound transducers, the radiation and receiving properties of the ultrasound transducers should not be altered by water drops attached to their exposed acoustic areas 10. Due to the water drops, side radiation lobes may occur besides the desired main radiation lobes. These radiation side lobes may disturb the runtime measurement in that the emitted acoustic signal gets on a shorter direct way via one of the side radiation lobes to the ultrasound transducer on the receiver side. The geometry or topology of the exposed acoustic area 10 of the airborne sound transducer 1 determines the radiation behavior of the ultrasound transducer as an interface to the air in the surroundings. By changing the topology of the interface towards the air from a plane surface to a topology with hills and valleys due to water drops, the phase-correlated wave front of the radiated airborne sound becomes a radiation with chaotic phase relations and a therefore undefined radiation lobe. Due to the hydrophilization of the outer surface 12, the formation of water drops on the exposed acoustic area 10 is avoided. Instead, the water is spread out, i.e. distributed over the outer surface 12 so that it does not essentially alter the topology of the exposed acoustic area 10 and does not affect the directed radiation of airborne sound.

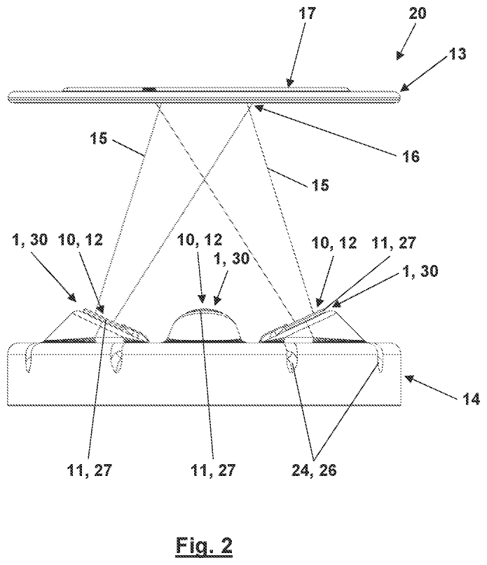

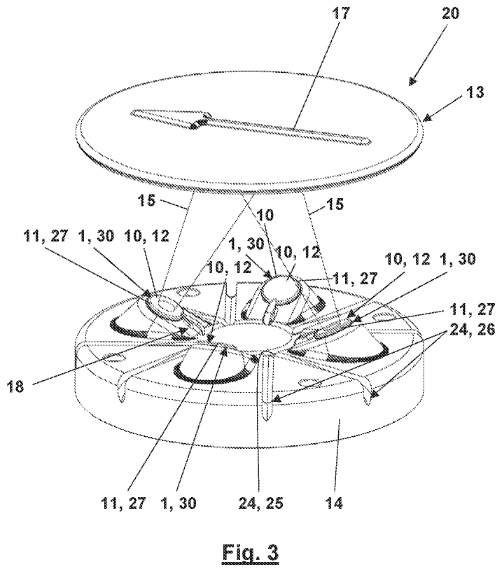

The ultrasound anemometer illustrated in FIG. 2 and FIG. 3 includes a total of four ultrasound transducers 30 made as airborne sound transducers 1 according to FIG. 1A and FIG. 1B. The four ultrasound transducers 30 essentially only with their thin metal sheet shaped bodies 11 comprising the outer surfaces 12 and thus forming the exposed acoustic areas 12 protrude beyond a shaped body 14, for example made of plastic or aluminum. From a vibration technology point of view, i.e. acoustically, the ultrasound transducers 30 are decoupled from the shaped body 14 and, by means of the sealing bulge 6 of the protective sleeve 5, the ultrasound transducers 30 are sealed with regard to the shaped body 14. With their radiation or receiving lobes 15 the four airborne sound transducers 1 are directed onto a reflector surface 16 in a center of the reflector 13. In sound propagation direction via the reflector surface 16, the airborne sound transducers 1 are facing each other in pairs in two directions which are orthogonal to each other. One of these directions is indicated on the upper side of the reflector 13 by means of a direction symbol 17. With this arrangement of the airborne sound transducers, velocities of air or any other gas which passes through between the airborne sound transducers 1 and the reflector 13 are measurable in both directions running parallel to the reflector surface 16 by means of detecting the signal runtimes. Here, it is to be understood that even though airborne sound transducers 1 and their air impedance matching layers 4 are mentioned here, the ultrasound anemometer 10 may also be used for measuring the velocities of other gases out of which a liquid may be precipitated on the exposed acoustic area 10.

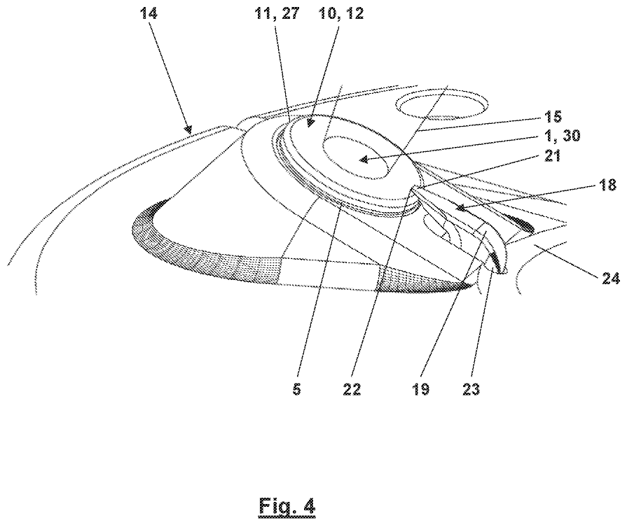

It is already visible in FIG. 2 and FIG. 3, and it is highlighted in FIG. 4 that starting from the shaped body 14, a water pickup arm 18 laterally extends up in front of the respective outer surface 12. A surface 19 of the water pickup arm 18 is also hydrophilic and preferably even more hydrophilic than the outer surface 12 so that then, when water accumulating on the outer surface 12 gets into contact with the free end of the water pickup arm 18, the water wets the surface 19 and is thus removed from the outer surface 12. This effect is further supported in that the free end 21 of the water pickup arm 18 is arranged next to a lowermost area 22 of the outer surface 12 and that a base 23 of the water pickup arm 18 is positioned even lower so that the gravity leads the water to the base 23 from where the water gets in a drainage groove 24 in the shaped body 14. The drainage groove 24 includes a ring channel 25 and branch off channels 26 with distinct slope leading from the ring channel 25 to the outer circumference of the shaped body 14. Via the branch off channels 26, the water is removed, even if the surface of the shaped body 14 is not hydrophilic.

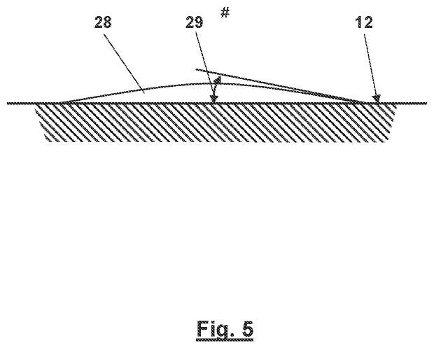

FIG. 5 explains the contact angle 29 occurring when wetting the outer surface 12 with water 28. The contact angle 29 represents an equilibrium between the boundary surface tensions between the wetting liquid water 28 and the outer surface 12, between the surrounding air and the water 28 and between the surrounding air and the outer surface 12. This equilibrium, besides material properties, is also dependent on any structuring of the outer surface 12 which has an effect on the boundary surface tension between the water 28 and the outer surface 12.

Many variations and modifications may be made to the preferred embodiments of the invention without departing substantially from the spirit and principles of the invention. All such modifications and variations are intended to be included herein within the scope of the present invention, as defined by the following claims.

1. An airborne sound transducer comprising
an electromechanical transducer,
an air impedance matching layer arranged on an acoustically active surface of the electromechanical transducer, and
a cover arranged on the air impedance matching layer, an outer surface of the cover forming an exposed acoustic area of the airborne sound transducer,
wherein the outer surface is hydrophilic such that a contact angle of water on the outer surface is less than 60°.

2. The airborne sound transducer of claim 1, wherein the contact angle of water on the outer surface is at least one of less than 40°, less than 20° and less than 10°.

3. The airborne sound transducer of claim 1, wherein the outer surface is a hydrophilized metal surface.

4. The airborne sound transducer of claim 3, wherein the metal surface is hydrophilized by at least one of oxidation, carbonization and roughening.

5. The airborne sound transducer of claim 3, wherein a metal component of the metal surface is at least predominantly consisting of zinc, copper, stainless steel or titanium.

6. The airborne sound transducer of claim 3, wherein the outer surface is the outer surface of a shaped body which is a layer of the cover and made of thin metal sheet.

7. The airborne sound transducer of claim 6, wherein the shaped body is arranged on a further layer of the cover, which is made of plastic.

8. The airborne sound transducer of claim 7, wherein the further layer is part of an elastic protective sleeve enclosing the air impedance matching layer.

9. An apparatus comprising
an airborne sound transducer including
an electromechanical transducer,
an air impedance matching layer arranged on an acoustically active surface of the electromechanical transducer, and
a cover arranged on the air impedance matching layer, an outer surface of the cover forming an exposed acoustic area of the airborne sound transducer,
wherein the outer surface is hydrophilic such that a contact angle of water on the outer surface is less than 60°; and
a water pickup arm, which laterally extends up to in front of a lowermost area of the outer surface.

10. The apparatus of claim 9, wherein the water pickup arm has a hydrophilic surface, wherein a contact angle of water on the hydrophilic surface is at least one of less than 60°, less than 40°, less than 20° and less than 10°.

11. The apparatus of claim 9, wherein a free end of the water pickup arm is arranged at a distance in front of the outer surface, which, in a direction normal to the outer surface, is in a range from 0.05 to 1.0 mm.

12. The apparatus of claim 9, wherein a free end of the water pickup arm, in a direction parallel to the outer surface, laterally ends at a distance up to 0.1 mm besides the outer surface or overlaps with the outer surface by up to 2 mm.

13. The apparatus of claim 9, wherein a free end of the water pickup arm is arranged at a distance in front of the outer surface, which, in a direction normal to the outer surface, is in a range from 0.1 mm to 0.5 mm, and wherein a free end of the water pickup arm, in a direction parallel to the outer surface, laterally ends at a distance up to 0.05 mm besides the outer surface or overlaps with the outer surface by up to 0.5 mm.

14. The apparatus of claim 9, wherein a base of the water pickup arm, in vertical direction, is arranged at a distance of at least one of at least 0.5 mm, 1 mm, 2 mm and 5 mm below the lowermost area of the outer surface.

15. The apparatus of claim 9, wherein a base of the water pickup arm is arranged in a water drainage groove whose bottom falls off away from the base.

16. The apparatus of claim 15, wherein the drainage groove is provided in a shaped body at which the water pickup arm is supported in a spatially fixed way and with regard to which the airborne sound transducer is sealed with an elastic seal.

17. An ultrasound anemometer comprising
a reflector and
at least two airborne sound transducers of claim 1,
wherein the at least two airborne sound transducers are directed towards a reflector surface and oppose each other when viewed in sound propagation direction via the reflector surface.

18. The ultrasound anemometer of claim 17, comprising a water pickup arm a water pickup arm, which laterally extends up to in front of a lowermost area of the outer surface

19. The ultrasound anemometer of claim 17, wherein the reflector surface is hydrophilic, wherein a contact angle of water is at least one of less than 60°, less than 40°, less than 20° and less than 10°.

20. The ultrasound anemometer of claim 17, wherein the reflector surface is oriented horizontally and arranged above or below the airborne sound transducers.
